(19) United States
(12) Patent Application Publication
(10) Pub. No.: US 2009/0286452 A1
(43) Pub. Date: Nov. 19, 2009

(54) Nursing Brassiere

(76) Inventor: Rodney D Grayson, Jackson, MS (US)

Correspondence Address: CROSSLEY PATENT LAW, 236 South Third Street, #287, MONTROSE, CO, 81401, US

(21) Appl. No.: 12/122,040

(22) Filed: May 16, 2008

(51) Int. Cl. A41C 3/04; A61J 13/00

(52) U.S. Cl. 450/36; 450/37; 128/890

(57) ABSTRACT

A nursing brassiere providing nipple protection against discomfort associated with breast-feeding having two identical cups, each having a centered aperture to expose a woman's nipple and interchangeable pad and shield attached via snaps to cover the aperture and a flap to cover the pad or shield. The pad is flexible and absorbent to prevent leaking, while the shield has a nipple with a drinking opening to allow an infant to breast feed. The shield also has a plastic ring seal to prevent leaking onto a woman's skin or clothes during breast feeding.

### FIELD OF THE INVENTION

The present invention relates to a brassiere and, more specifically, a nursing brassiere designed to provide nipple protection against discomfort associated with breast-feeding.

### BACKGROUND OF THE INVENTION

A variety of nursing brassieres and nipple protection devices are provided by prior art patents. For example, one prior art patent teaches a nipple protection device for breast-feeding mothers which has a nipple portion protecting upwardly from an arched shield portion, with a slit provided in the nipple portion to accommodate infant drinking breast-milk. In the prior art, there is an areola/nipple surgical wound protector that includes a sterile pad having an upper surface, a lower non-stick surface, and a centrally-located pad opening extending through it. A nipple protection device which has raised edges to simulate a real nipple is taught by the prior art. Still another prior art patent teaches a breast shield which supports the breast and has a removable flap which will expose the nipple during breast feeding. Prior art also provides a brassiere which has a flap which can cover and uncover the breast for infant breast feeding. What is needed is a device which provides nipple protection while nursing, which is easily and conveniently utilized, which provides support to the mother's breast, which is reusable, and which is washable. The present nursing brassiere addresses the foregoing needs by providing a brassiere having an aperture to expose each breast over which an interchangeable protective plastic nipple-shaped shield, having at least one drinking opening, is snapped into place to breast feed an infant, the shield being removed and replaced by a disposable protective pad which is snapped into place over the aperture when the user is not breast feeding. The brassiere, shield and pad are washable and reusable. The present nursing brassiere eliminates discomfort associated with breast-feeding, such as chapped, bruised, bleeding or tender nipples.

### SUMMARY OF THE INVENTION

The present nursing brassiere concerns that of a new and improved nursing brassiere for use by an individual to cover and protect a woman's breasts. The brassiere includes two breast cups comprising a left cup and a right cup identical to the left cup, which are designed to cover a left breast and a right breast when the brassiere is worn. The present nursing brassiere has an aperture in the center of each cup to expose a breast nipple. Engagement means surround the aperture for attaching a pad or a shield which are interchangeable cover means for the aperture. The pad is flexible and absorbent and is attached to the exterior side of the brassiere to cover the aperture to prevent leakage of milk from the breast. The pad further serves to provide an extra layer of protection to keep the breasts warm and protect them against cold drafts, thereby ensuring the wearer against caked nipples. The shield is semi-flexible and has a circular base portion with a plastic ring seal around the circumference of the base portion and a nipple portion protruding from the center of the base portion. The nipple has a drinking opening allowing an infant to obtain milk from the breast without directly contacting the breast, thereby eliminating chapping, bruising, bleeding or tender nipples. The drinking opening is formed by at least one circular orifice. The nursing brassiere also provides a flap which folds over either the pad or the shield and attaches to the exterior side of the brassiere to conceal and secure the pad or shield to the brassiere. The plastic ring seal serves to prevent leakage during breast feeding which may damage the nursing mother's clothing, which may be a source of discomfort for the nursing mother, and which requires cleanup after breast feeding.

The present nursing brassiere may be formed of soft disposable fabric and may be formed of disposable cloth. The brassiere and pad may be laundered and the shield may be cleaned for reuse. The pad may, alternatively, may be thrown away after one use.

The present nursing brassiere also serves to allow the breasts to be easily and conveniently exposed for nursing purposes while also supporting the breasts thereby preventing the breasts from sagging, enabling milk ducts to retain their proper position for breast feeding. The present nursing brassiere may be used by a woman whose baby has started to teethe or bites frequently during the nursing process. Thus, the present device may encourage breast feeding for a longer period of time than would be the case if a nursing mother's breasts were chapped, bleeding, bruised or tender or if a baby was biting, thereby allowing nursing infants to receive additional health benefits associated with breast feeding over a longer period of time.

The present nursing brassiere is easily and efficiently manufactured and marketed, is of durable and reliable construction, and is economically affordable and available for relevant market segment of the purchasing public

Thus been outlined, rather broadly, the more important features of a nursing brassiere that the detailed description thereof that follows may be better understood and in order that the present contribution to the art may be better appreciated. There are, of course, additional features of the nursing brassiere that will be described hereinafter and which will form the subject matter of the claims appended hereto.

In this respect, before explaining at least one embodiment of the nursing brassiere in detail, it is to be understood that the nursing brassiere is not limited in its application to the details of construction and to the arrangements of the components set forth in the following description or illustrated in the drawings. The nursing brassiere is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present nursing brassiere. It is important, therefore, that the claims be regarded as including such equivalent constructions insofar as they do not depart from the spirit and scope of the present invention.

An object of the present nursing brassiere is to eliminate discomfort associated with breast feeding as a result of chapped, bleeding, bruised or tender nipples.

Another object of the present nursing brassiere is to protect a nursing mother from being bitten by a teething infant or infant who bites frequently during breast feeding.

Yet another object of the present nursing brassiere is to support a nursing woman's breasts to prevent sagging breasts, thereby keeping nipples in proper position for nursing.

Still another object of the present nursing brassiere is to provide an extra layer of protection to keep the breasts warm and protect them against cold drafts, thereby ensuring the wearer against caked nipples.

Still even another object of the present nursing brassiere is to prevent leakage during breast feeding and during non-breast feeding time.

Still yet another object of the present nursing brassiere is to provide a re-usable and washable nursing brassiere.

It is therefore even yet another object of the present invention to provide a nursing brassiere which has all of the advantages of the prior art and none of the disadvantages.

It is a further object of the present invention to provide a nursing brassiere which may be easily and efficiently manufactured and marketed.

It is an even further object of the present invention to provide a nursing brassiere which is of durable and reliable construction.

It is a still even further object of the present invention to provide a nursing brassiere which is economically affordable and available for relevant market segment of the purchasing public.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 is a front perspective view illustrating both flaps in closed position and an aperture in each breast portion in broken lines.

FIG. 2 is a front perspective view illustrating a flap in open position with a pad to be attached thereby covering an exposed aperture.

FIG. 3 is a front perspective view illustrating a flap in open position with a shield to be attached thereby covering an exposed aperature.

FIG. 4 is a front perspective view illustrating a flap in open position with a shield attached in position to cover an aperture.

FIG. 5 is a cross-sectional view taken along line 5-5 of FIG. 2.

FIG. 6 is a cross-sectional view taken along line 6-6 of FIG. 4.

### DESCRIPTION OF THE PREFERRED EMBODIMENT

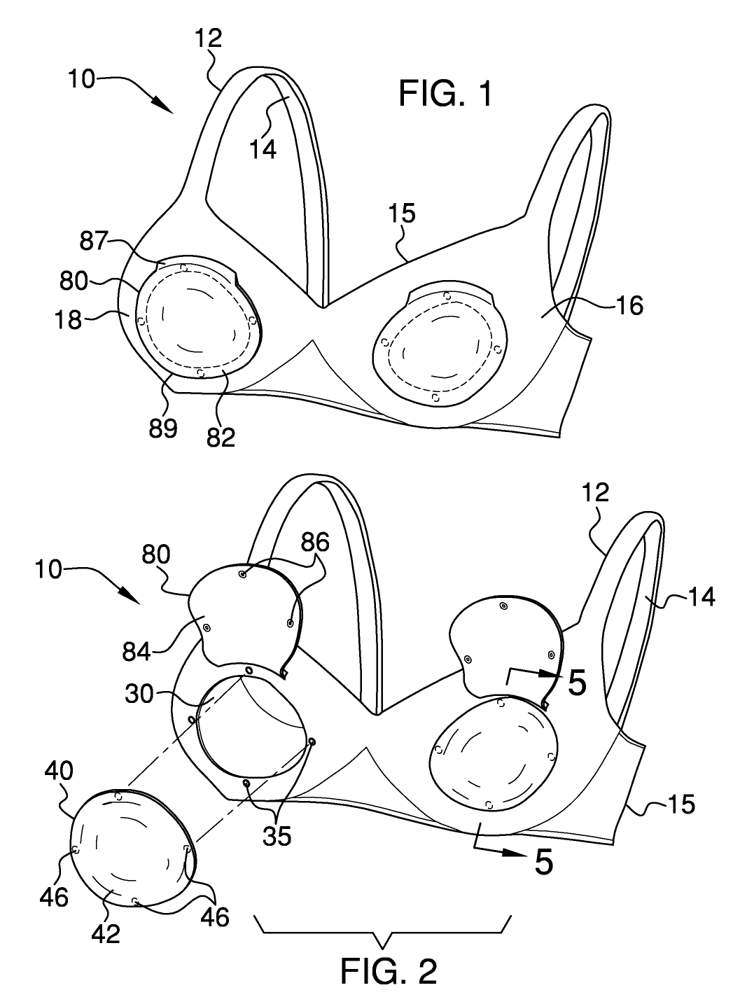

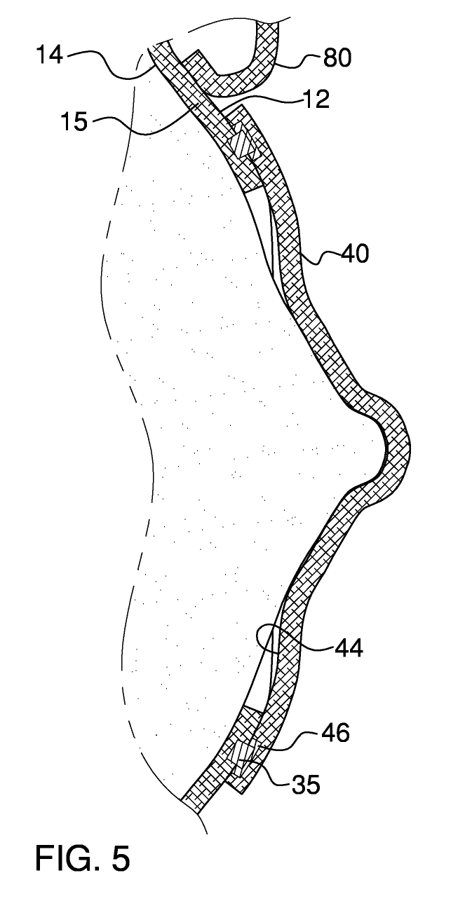

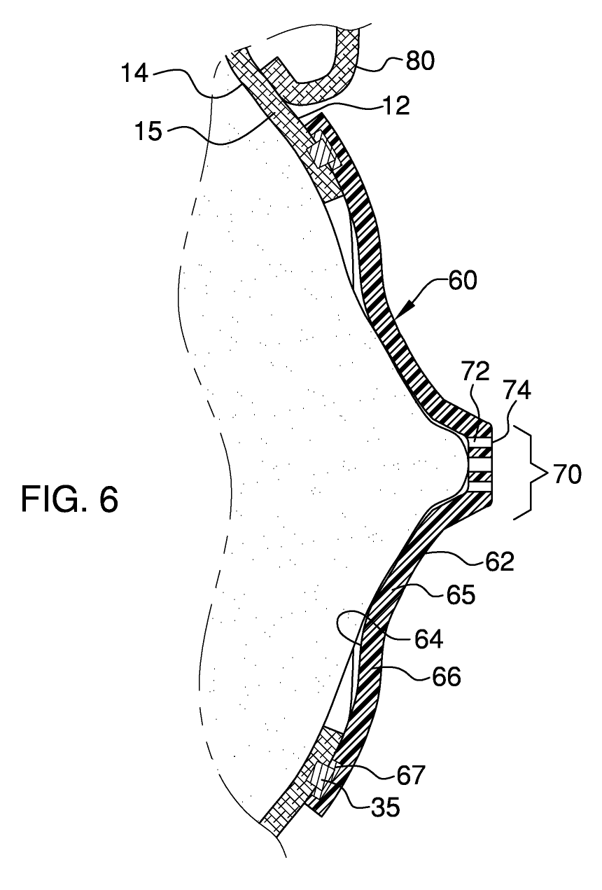

With reference now to the drawings, and in particular to FIGS. 1 through 6 thereof, a new nursing brassiere embodying the principles and concepts of the present invention and generally designated by the reference numeral 10 will be described.

As best illustrated in FIGS. 1 through 6, the present nursing brassiere 10 provides a brassiere 15 which has an exterior side 12 and an interior side 14 and includes a pair of identical cups comprising a right cup 16 and a left cup 18. When the nursing brassiere 10 is being worn, the right cup 12 is designed to be placed over a right breast, while the left cup 14 is designed to be placed over a left breast.

Each cup 16, 18 of the brassiere 15 has an aperture 30 in the center of each cup 16, 18. The aperture 30 allows a breast nipple to be exposed for breast feeding. A plurality of spaced-apart engagement means 35 are positioned on the exterior side 12 of the brassiere 15 to surround the aperture 30. An aperture cover means, including an interchangeable pad 40 and a shield 60, is provided. In addition, a flap 80 for concealing the aperture cover means is provided. The pad 40 has a front side 42 and a rear side 44. The pad 40 is flexible and absorbent and the rear side 44 has a plurality of spaced-apart attachment means 46 which selectively removably engage the engagement means 35 thereby allowing the pad 40 to selectively cover the aperture 30 interchangeably with the shield 60. The flexibility of the pad 40 allows the pad 40 to conform to the shape of the wearer's breast. The pad 40, when in place to cover the aperture 30, prevents leakage of milk from the breast. The pad 40 further serves to provide an extra layer of protection to keep the breasts warm and protect them against cold drafts, thereby ensuring the wearer against caked nipples. The pad 40 is formed of soft, disposable fabric, which may be cloth.

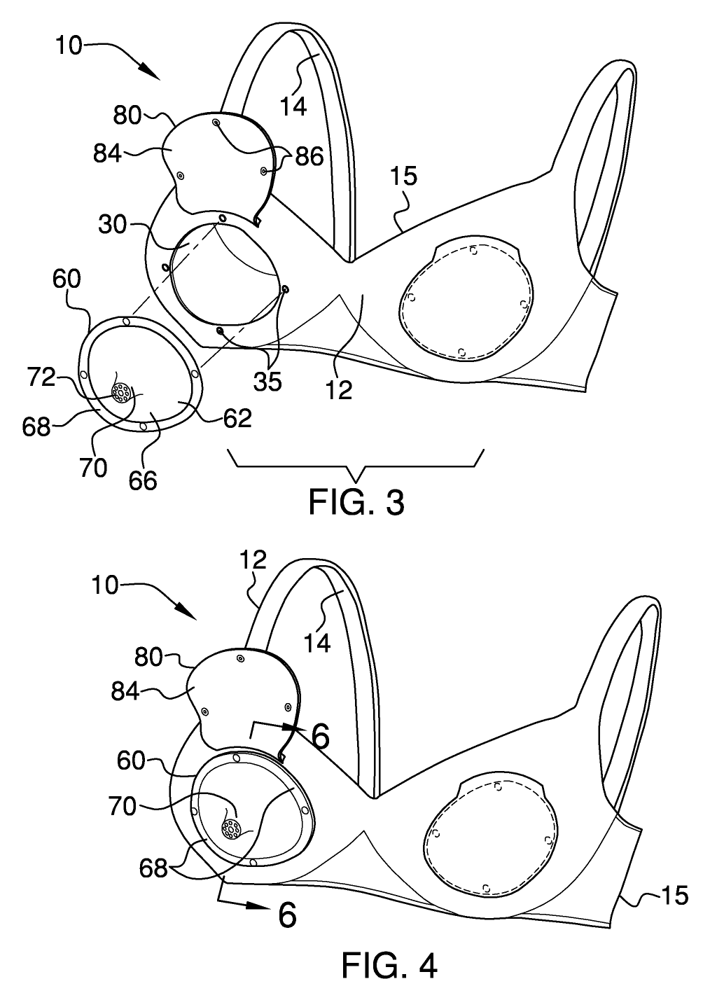

The shield 60 is semi-flexible plastic. The shield 60 has a front wall 62 and a rear wall 64 defining an interior portion 65 therebetween. The shield 60 further has a circular base portion 66 and a nipple portion 70. The base portion 66 has a plastic ring seal 68 continuously along the circumference of the base portion 66, as shown in FIG. 3. The nipple portion 70 protrudes outwardly from the center of the base portion 66. The nipple portion 70 is provided with at least one drinking opening 72 formed by at least one circular orifice 74. The plastic ring seal 68 prevents leakage during breast feeding onto a wearer's skin or clothes. A plurality of securement means 67 on the rear wall 64 of the shield 60 selectively removably engage the engagement means 35 surrounding the aperture 30, thus allowing the shield 60 to be interchanged the pad 60 to cover the aperture 30 while breast feeding. The drinking opening 72 in the nipple portion 70 allows an infant to obtain milk from the breast without directly contacting the breast, thereby eliminating chapping, bruising, bleeding and tender nipples.

The flap 80 has a top side 82, a bottom side 84 having a plurality of fastening means 86 which removably engage the engagement means 35 surrounding the aperture 30, an upper edge 87 which foldably engages the brassiere 15 exterior side 12, and a lower edge 89. The flap 80 folds over to removably covers the 40 pad and the shield 60, whichever may be in place over the aperture. The flap 80 may also conceal the aperture 30 in the event neither the pad or shield are in position to cover the aperture 30.

The engagement means 35 surrounding the aperture, the attachment means 46 on the rear side 44 of the pad 40, the securement means 67 on the rear wall 64 of the shield 60, and the fastening means 86 on the bottom side 84 of the shield 80 may be male and female interconnecting snap portions as shown in FIGS. 1-6 or other implements, such as hook and loop fasteners, for interconnecting the pad 40, the shield 60, and the flap 80 to the exterior side 12 of the brassiere 15 to cover the aperture 30.

In use, the present nursing brassiere 10 serves to allow the breasts to be easily and conveniently exposed for nursing purposes, while also supporting the breasts thereby preventing the breasts from sagging, enabling milk ducts to retain their proper position for breast feeding.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What I claim as my invention is:

1. A nursing brassiere comprising, in combination:
a brassiere having an exterior side, an interior side, said exterior and interior side defining an interior portion therebetween, the brassiere further having a pair of identical cups comprising a right cup and a left cup, each cup comprising:
an aperture in the center of each cup, wherein said aperture exposes a breast nipple;
a plurality of spaced-apart engagement means positioned on the exterior side of said brassiere, wherein said engagement means surround said aperture;
aperture cover means, said aperture cover means selected from the group consisting of:
a flexible, absorbent removable pad having a front side and a rear side, said rear side having a plurality of spaced-apart attachment means selectively removably engaging said engagement means, wherein said pad selectively covers said aperture; and
a semi-flexible shield having a front wall and a rear wall, said shield comprising:
a circular base portion having a plastic ring seal running continuously along the circumference of said base portion;
a nipple portion protruding outwardly from the center of said base portion, the nipple portion being provided with at least one drinking opening formed by at least one circular orifice;
a plurality of securement means on said rear wall of said shield, said securement means selectively removably engaging said engagement means wherein said shield selectively, interchangeably with said pad, covers said aperture;
a flap having a top side, a bottom side having a plurality of fastening means removably engaging said engagement means, an upper edge foldably engaging said exterior side of said brassiere, and a lower edge, wherein said flap selectively removably covers said pad and said shield.

2. The nursing brassiere of claim 1 wherein said engagement means, said attachment means, said securement means, and said fastening means are male and female interconnecting snap portions and further wherein said shield is plastic.

3. The nursing brassiere according to claim 1 wherein said pad is formed of soft, disposable fabric.

4. The nursing brassier of claim 2 wherein said pad is formed of soft, disposable fabric.

5. The nursing brassiere according to claim 3 wherein said soft, disposable fabric is cloth.

6. The nursing brassiere of claim 4 wherein said soft, disposable fabric is cloth.
